(19) United States
(12) Patent Application Publication
(10) Pub. No.: US 2013/0015689 A1
(43) Pub. Date: Jan. 17, 2013

(54) CHILD CONVEYANCE DEVICE AND BLANKET FOR SAME

(71) Applicants: Kathleen Maclary, Allston, MA (US); Trung Phung, Milton, MA (US)

(72) Inventors: Kathleen Maclary, Allston, MA (US); Trung Phung, Milton, MA (US)

(73) Assignee: MONAHAN PRODUCTS, LLC, Hingham, MA (US)

(21) Appl. No.: 13/181,228

(22) Filed: Jul. 12, 2011

(51) Int. Cl. A47D 15/00; B23P 11/00; A47C 31/00

(52) U.S. Cl. 297/219.12; 29/428

(57) ABSTRACT

Aspects and embodiments of the present disclosure are directed generally to a child conveyance device having a bumper bar and a blanket comprising at least one loop affixed to the front surface configured to detachably attach the blanket to the bumper bar.

### BACKGROUND

Aspects and embodiments of the present disclosure are directed generally to child conveyance devices, for example, strollers and/or car seats, and to blankets for use with such child conveyance devices.

### SUMMARY

In accordance with an aspect of the present disclosure there is provided a child conveyance device including a frame assembly. The device comprises a blanket including a front surface, a back surface, and at least one loop affixed to the front surface, the at least one loop having a first end and a second end, the at least one loop being configured to detachably attach the blanket to the frame assembly.

In some embodiments, the frame assembly includes a bumper bar. The at least one loop may be configured to detachably attach the blanket to the bumper bar and secure the blanket below the bumper bar by detachably attaching the blanket to the bumper bar.

In accordance with some embodiments the first end and the second end of the at least one loop is permanently attached to the blanket, and in accordance with some embodiments one of the first end and the second end of the at least one loop is removably attached to the blanket. In some embodiments the one of the first end and the second end of the at least one loop is removably attached to the blanket with a fastening means selected from the group consisting of buttons and button holes, snaps and fasteners, hooks and eyes, clasps, clips, and hook and loop fasteners. In accordance with some embodiments the blanket further comprises an upper portion configured to fold over the bumper bar.

In accordance with some embodiments the blanket further comprises a pocket configured to enclose the blanket when folded into itself.

In accordance with some embodiments the blanket has a width substantially equal to a width of the child conveyance device.

In accordance with some embodiments the child conveyance device further comprises a support surface configured to support a child. The blanket has a length substantially equal to a length of the support surface.

In accordance with some embodiments the child conveyance device comprises a stroller. In some embodiments the stroller comprises a frame, and the bumper bar has at least one end. The at least one end of the bumper bar is detachable from the frame.

In accordance with some embodiments the child conveyance device comprises a car seat.

In accordance with some embodiments the blanket has a top edge and each of the plurality of loops are positioned an equal distance from the top edge.

In accordance with an aspect of the present disclosure there is provided a child conveyance device. The child conveyance device comprises a blanket including a front surface, and a first connecting member coupled to the front surface, the connecting member being sized and shaped to accommodate a portion of a bumper bar of the child conveyance device.

In accordance with some embodiments the first connecting member comprises a tube. In some embodiments the tube comprises a same material as the front surface of the blanket. In some embodiments the tube extends substantially across a width of the blanket.

In accordance with some embodiments the child conveyance device further comprises a second connecting member positioned coaxially with the tube. In some embodiments the first connecting member and the second connecting member are located on the blanket at positions such that the first connecting member accommodates a portion of the bumper bar proximate a proximal end of the bumper bar while the second connecting member accommodates a portion of the bumper bar proximate a distal end of the bumper bar.

In accordance with some embodiments the tube comprises a rigid member. In some embodiments the connecting member further comprises a layer of padding disposed over the rigid member.

In accordance with some embodiments the connecting member is configured to accommodate substantially an entire length of the bumper bar.

In accordance with a further aspect of the present disclosure there is provided a child conveyance device. The child conveyance device comprises a frame assembly, a bumper bar coupled to the frame assembly, and a blanket including a front surface, a back surface, and at least one loop affixed to the front surface. The at least one loop has a first end and a second end. The at least one loop is configured to detachably attach the blanket to the bumper bar and to secure the blanket below the bumper bar.

In accordance with some embodiments the first end and the second end of the at least one loop is permanently attached to the blanket and in accordance with some embodiments one of the first end and the second end of the at least one loop is removably attached to the blanket. In some embodiments the one of the first end and the second end of the at least one loop is removably attached to the blanket with a fastening means selected from the group consisting of buttons and button holes, snaps and fasteners, hooks and eyes, clasps, clips, and hook and loop fasteners.

In accordance with some embodiments the blanket further comprises an upper portion configured to fold over the bumper bar.

In accordance with some embodiments the blanket further comprises a pocket configured to enclose the blanket when folded into itself.

In accordance with some embodiments the blanket has a width substantially equal to a width of the child conveyance device.

In accordance with some embodiments the child conveyance device further comprises a support surface configured to support a child and the blanket has a length substantially equal to a length of the support surface.

In accordance with some embodiments the child conveyance device comprises a stroller.

In accordance with some embodiments the bumper bar comprises a distal end which is detachable from the frame.

In accordance with some embodiments the child conveyance device comprises a car seat.

In accordance with some embodiments the blanket has a top edge and each of the plurality of loops are positioned an equal distance from the top edge.

In accordance with a further aspect of the present disclosure there is provided a method of attaching a blanket to a child conveyance device. The method comprises providing a child conveyance device including a frame and a bumper bar having a proximal end removably attached to the frame. The method further comprises providing a blanket including a front surface, a back surface, and at least one loop affixed to the front surface. The at least one loop has a first end and a second end. The at least one loop is configured to detachably attach the blanket to the bumper bar to and to secure the blanket below the bumper bar. The method further comprises attaching the at least one loop to the bumper bar.

In accordance with some embodiments attaching the at least one loop to the bumper bar comprises detaching the proximal end of the bumper bar from the frame, inserting the proximal end of the bumper bar through the at least one loop, and re-attaching the proximal end of the bumper bar to the frame.

In accordance with some embodiments one of the first end and the second end of the at least one loop is removably attached to the blanket, and attaching the at least one loop to the bumper bar comprises removing the one of the first end and the second end of the at least one loop from the blanket, positioning the at least one loop about a portion of the bumper bar, and re-attaching the one of the first end and the second end of the at least one loop from the blanket.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an isometric view of a blanket in accordance with an embodiment of the present disclosure;

FIG. 2 is an isometric view of a blanket in accordance with another embodiment of the present disclosure;

FIG. 3 is a side view of a blanket in accordance with an embodiment of the present disclosure;

FIG. 4 is a side view of a blanket in accordance with an embodiment of the present disclosure;

FIG. 5 is a side view of a blanket in accordance with an embodiment of the present disclosure;

FIG. 6 is a side view of a blanket in accordance with an embodiment of the present disclosure;

FIG. 7 is a side view of a blanket in accordance with an embodiment of the present disclosure;

FIG. 8 is a side view of a blanket in accordance with an embodiment of the present disclosure;

FIG. 9 is a top plan view of a blanket in accordance with an embodiment of the present disclosure;

FIG. 10 is an isometric view of a blanket in accordance with an embodiment of the present disclosure mounted on a child conveyance device;

FIG. 11 is an isometric view of a blanket in accordance with an embodiment of the present disclosure mounted on a child conveyance device; and

FIG. 12 is an isometric view of a blanket in accordance with another embodiment of the present disclosure.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Parents or caregivers of young children or babies may be challenged with transporting a child while keeping the child warm and protected from the elements. When a child is placed in a child conveyance device, such as a car seat or a stroller, a caregiver may desire to cover the child with a blanket. The blanket may provide protection from the sun, wind, or rain, and/or may facilitate keeping the child warm while in the child conveyance device. A blanket simply placed on a child in a conveyance device may be subject to slipping off or being unintentionally removed from the child and/or the child conveyance device. For example, the child may kick the blanket off, the blanket may become entangled in an obstacle or impediment by to which the child conveyance device is passed, or the blanket may be blown off of the child or child conveyance device by, for example, a gust of wind. Some blankets may also present difficulties in folding and storing while not in use. For example, a blanket may be exposed to dirt while not in use or may present difficulties in maintaining a folded state during transportation.

Aspects and embodiments of the present disclosure are directed to a blanket which may be securely attached to a child conveyance device and to child conveyance devices including such a blanket. Embodiments of a blanket disclosed herein may be attached to a bumper bar of a child conveyance device such as a stroller or to a handle of a car seat or to, for example, a harness buckle strap of a child conveyance device. As used herein the term “child conveyance device” includes any apparatus, mobile or stationary, in which a child may be placed wherein it may be desirable to supply a blanket for the child. For example, a child conveyance device may be any of a stroller, a car seat, or a child swing. As used herein, the term “bumper bar” includes any rod or other member of a child conveyance device located above or in front of an area in which a child may be placed to which may be attached embodiments of blankets as described herein.

Blankets according to embodiments of the present disclosure may be resistant to inadvertent removal once secured in place on a child conveyance device. Blankets according to embodiments of the present disclosure may be secured to a child conveyance device in flexible configurations, for example in a configuration covering a child or a configuration covering the body of a child but leaving the child's head uncovered. Blankets according to embodiments of the present disclosure may include a built in storage pocket into which the remainder of the blanket may be folded. This may provide for easy storage or transportation of the folded blanket.

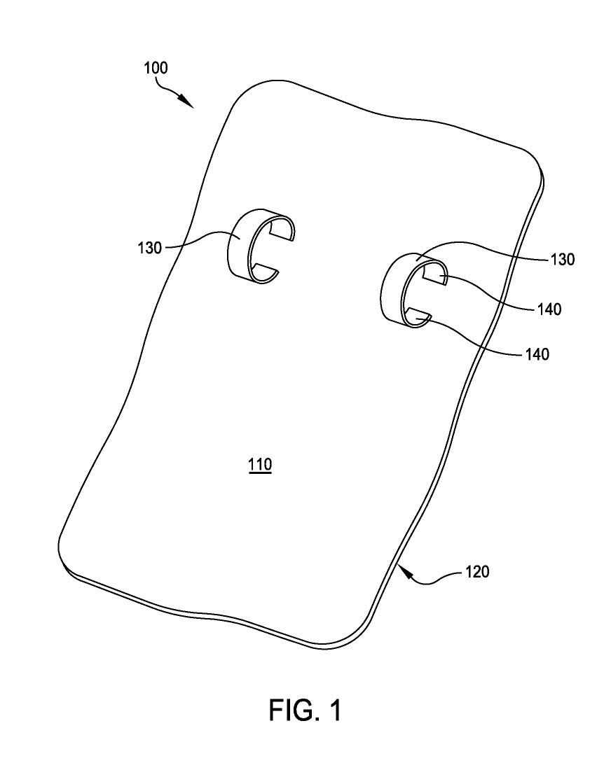

Referring to FIG. 1, there is illustrated a perspective view of a blanket 100 in accordance with an embodiment of the present disclosure. The blanket includes a front side 110, a back side 120, and one or more loops 130. The loops may include ends 140 which may be secured to the front side 110 of the blanket 100. In some embodiments, the blanket 100 may include two loops 130 as illustrated in FIG. 1, and in other embodiments may include greater than two loops 130. The loops 130 may in some embodiments be substantially identically sized, having, for example, substantially similar widths and lengths, and may be located at a substantially similar distance from an end of the blanket. In some embodiments, the loops 130 may be, for example, between about two and about six inches wide, between about three and about eight inches long, and between about 0.05 inches and about 0.5 inches thick, although the embodiments of the present disclosure are not limited to any particular dimensions for the loops 130.

The loops 130 may be formed from a same material as a surface of the blanket 100, for example, cotton, polyester, wool, or any other natural, synthetic, or blended fabric known in the art for use in forming blankets. The loops 130 may in some embodiments include a filling similar to a filling which may be included in the body of the blanket, for example, down or fleece. In other embodiments the loops may comprise a material different than that from which the blanket is formed. For example, in some embodiments the loops may include a stiffener material, such as a resilient polymer. The inclusion of a resilient material in the loops 130 may facilitate the maintenance of the loops in a configuration where at least a part of the loops extends away from the front surface of the blanket. This may make it easier for a user to insert an end of a bumper bar through the loops. In other embodiments the loops 130 may include an elastic material, for example, an elastomeric polymer. The inclusion of an elastic material in the loops may facilitate the loops forming a tight grip upon a bumper bar inserted through them. The loops may also in some embodiments include a friction enhancing material, for example, a polymer, on the internal surface thereof (the surface which would contact a bumper bar) to reduce the tendency of the loops to slide back and forth on a bumper bar. In further embodiments a cushioning material, for example, foam rubber, may be included on an external surface of the loops. This may facilitate the reduction in the potential for a child to injure itself by striking the bumper bar with a portion of its body.

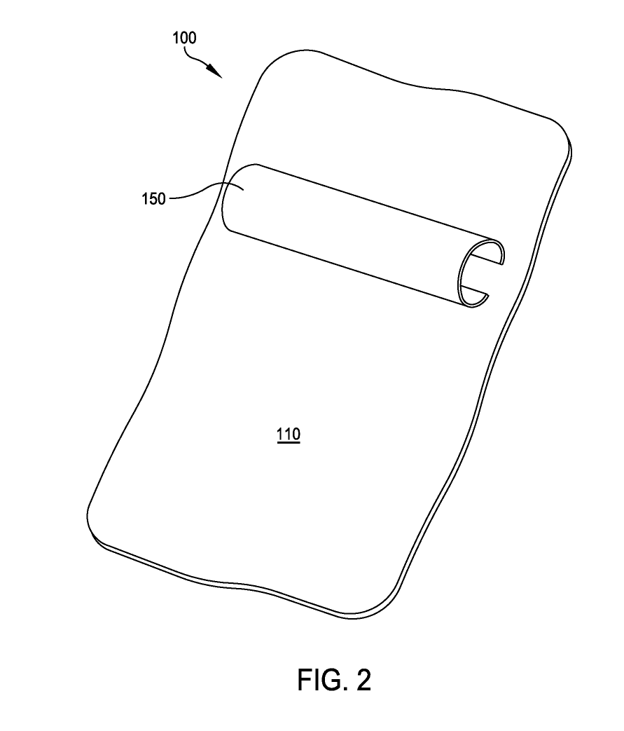

In some embodiments, an axis may be defined within each of the loops 130 parallel to a widthwise surface of the loops and each of the loops 130 may be arranged on the blanket 100 coaxially with one another. In further embodiments, the two loops 130 of FIG. 1 may be replaced with a single loop 150, which as illustrated in FIG. 2 to may extend substantially across the entire width of the blanket 100. The various permutations of dimensions and materials of construction described above with reference to the loops 130 may also apply to the single loop 150.

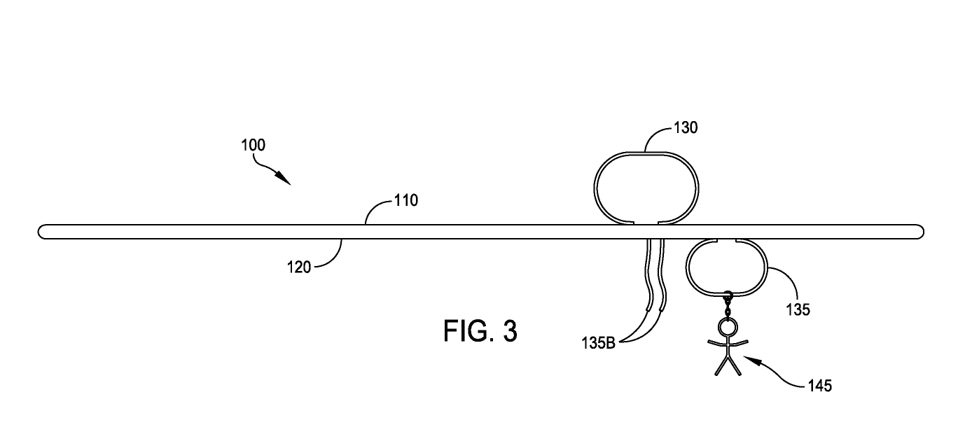

In some embodiments, the loops 130, or additional loops 135 (FIG. 3), provided on a surface of the blanket on the same side, or on a different side of the blanket from the loops 130 may be used for securing a toy 145, for example a light, a rattle, or a doll to the blanket, to provide a child secured in the child conveyance device with a hanging toy to amuse the child. The loops 135 may be formed in a similar manner and of similar materials as the loops 130, or may be formed of different materials or in different configurations, for example as one or more strings 135B attached to the blanket to which a toy may be secured.

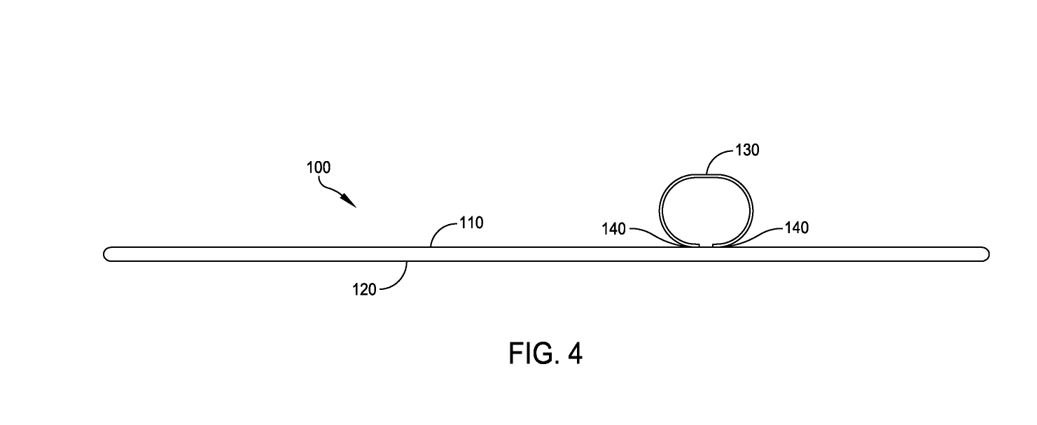

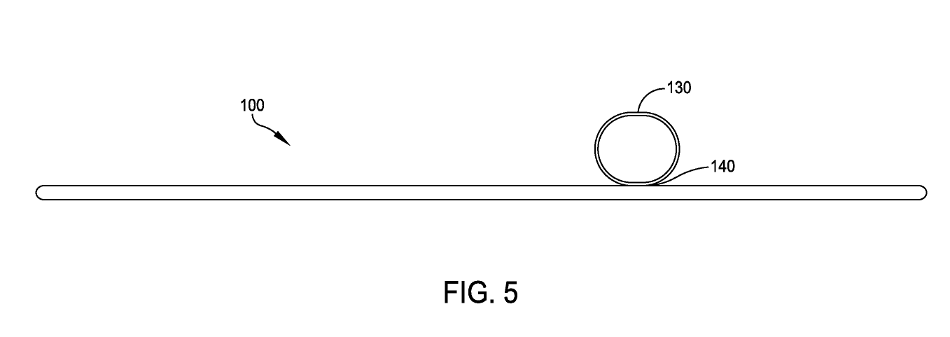

A side view of an embodiment of the blanket 100 is illustrated in FIG. 4. In this figure the ends 140 of the loops 130 (the loops are coaxial, so only one side of one loop is visible in this figure) are illustrated as affixed to the upper surface 110 of the blanket 100. The ends 140 of the loops 130 are affixed to the blanket 100 with a spacing between them. The ends 140 of the loops 130 may be affixed to the blanket by, for example, sewing, adhering, plastic welding or heat sealing, or any other method of permanently affixing one piece of material to another known in the art. In an alternate embodiment, illustrated in FIG. 5, the ends 140 of the loops 130 are affixed to substantially a same location on the upper surface 110 of the blanket 100. In some embodiments the loops 130 may be formed into a tubular configuration prior to being affixed to the blanket 100.

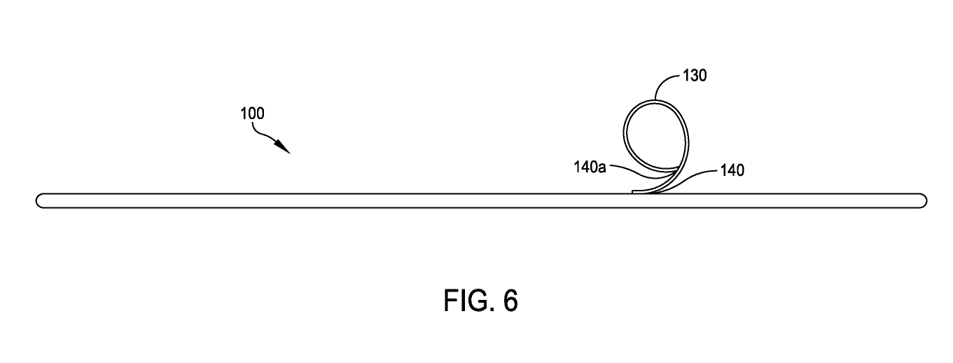

In another embodiment, such as is illustrated in FIG. 6, only one end 140 of the loop 130 may be secured to the blanket 110. The other end 140a of the loop may be secured to a portion of the material making up the loop at a distance spaced from the point at which the first end 140 of the loop 130 is attached to the blanket.

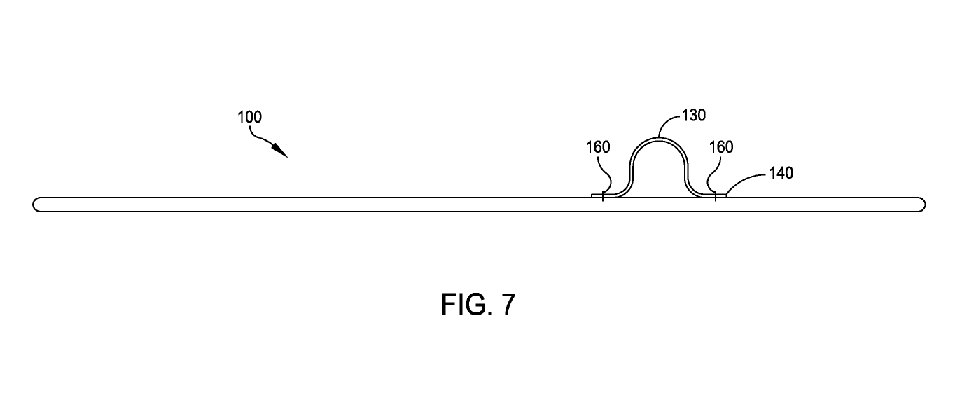

In another embodiment, one or more ends of one or more loops 130 may be releasably attached to the blanket. As illustrated in FIG. 7, both ends of a loop 130 may be secured to the blanket 100 by fasteners 160. These fasteners may be any one or more of, for example, buttons and button holes, snaps and fasteners, hooks and eyes, clasps, clips, hook and loop fasteners, or other fasteners known in the art that may be used to secure one piece of material to another. Providing for one or more ends of a loop 130 to be releasably attached to the blanket 100 may facilitate attaching the blanket to a bumper bar of a child conveyance device without having to find a free end of the bumper bar or detach an end of the bumper bar from the child conveyance device to slide the loop or loops 130 onto the bumper bar.

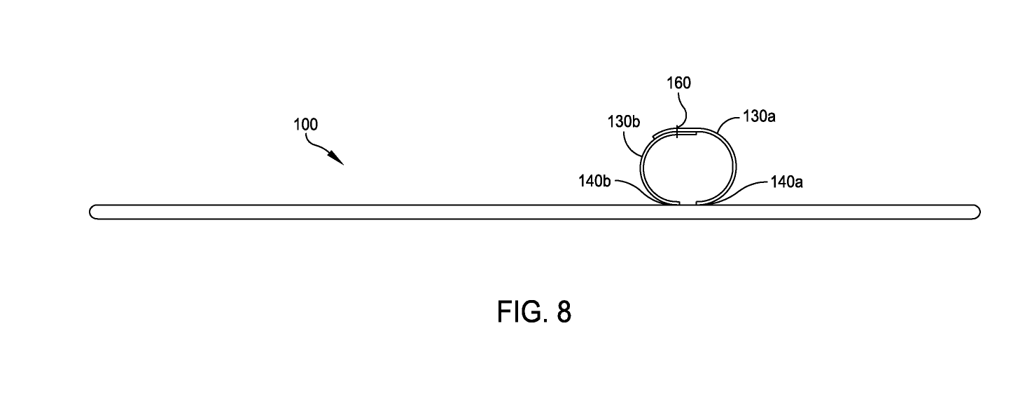

In a further embodiment, as illustrated in FIG. 8, one or more loops may comprise two sections of material, sections 130a and 130b. Each of these sections may be secured to the blanket 100 at first ends 140a and 140b, respectively. The other ends of the sections 130a and 130b may be secured to each other by one or more fasteners 160. These fasteners may be any one or more of, for example, buttons and button holes, snaps and fasteners, hooks and eyes, clasps, clips, hook and loop fasteners, or other fasteners known in the art that may be used to secure one piece of material to another.

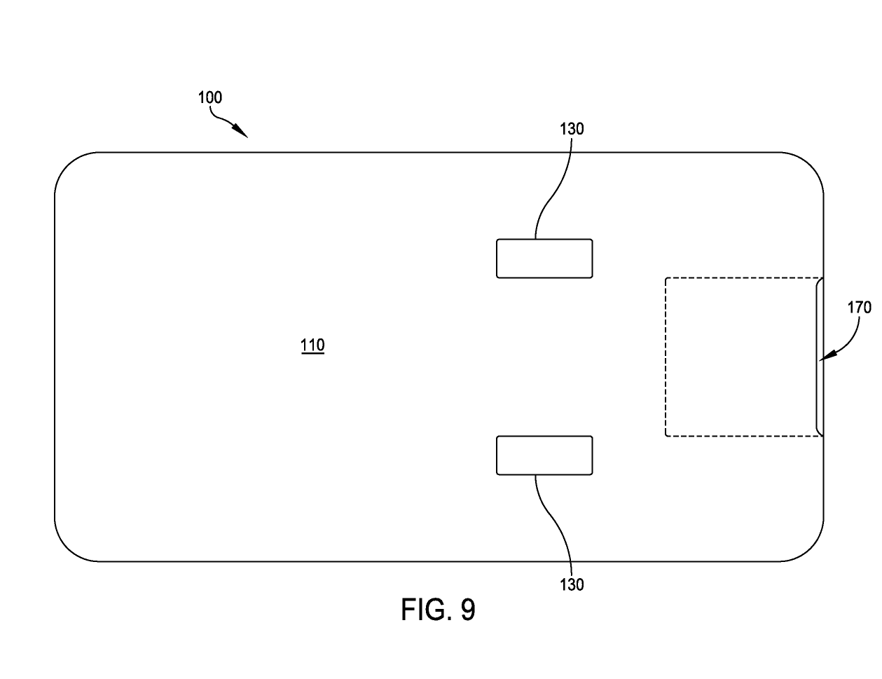

In some embodiments, the blanket 100 may include a pocket 170 attached to a portion thereof, for example to an edge of the blanket, or applied to the body of the blanket. In some embodiments, the pocket 170, as is illustrated in FIG. 9, may be sewn in place on a top surface of the blanket. In some embodiments the pocket 170 may be permanently attached to the blanket and in other embodiments one or more edges of the pocket 170 may be releasably attached to the stroller by a fastener set including one or more of for example, buttons and button holes, snaps and fasteners, hooks and eyes, clasps, clips, hook and loop fasteners, or other fasteners known in the art that may be used to secure one piece of material to another. In some embodiments, the blanket may be folded up and placed within the pocket 170 for ease of transport or storage. The pocket may be formed from a polymeric material or include a polymeric coating to provide a waterproof container for the blanket. In some embodiments, when the blanket is folded up and placed within the pocket 170, there may be sufficient space left in the pocket for the inclusion of additional items, for example, toys or pacifiers for a child.

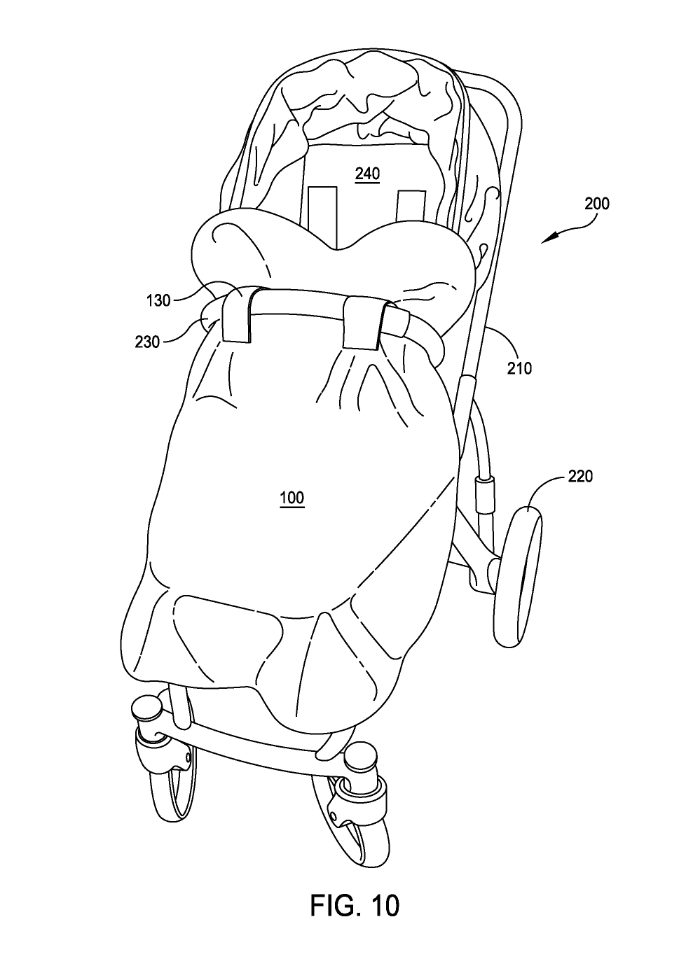

A blanket 100 in accordance with any of the above embodiments, or combinations thereof may be secured to a child conveyance device such as a car seat or a stroller to provide warmth or protection from sunlight or the elements to a child residing within the child conveyance device. An embodiment of a stroller 200 with which the blanket 100 may be used is illustrated in FIG. 10. The stroller 200 may include a frame 210, one or more wheels 220, a bumper bar 230, and a support surface 240 or seat. A blanket 100 in accordance with embodiments of the present disclosure may be secured to the bumper bar 230 of the stroller 200 by fitting the bumper bar 230 through the one or more loops 130 on the blanket. In some embodiments, the blanket may be sized to substantially cover the support surface 240 to provide full coverage to a child in the stroller 200.

Additional straps (not shown) may be provided on the blanket, for example on edges of the blanket to additionally secure the blanket to one or more portions of the stroller frame 210. In some embodiments, the blanket may alternatively or additionally include fasteners configured to secure the ends/edges of the blanket to other parts of the child conveyance device, for example, hook and loop fasteners could be used to secure the blanket to one or more sides or to a bottom of the child conveyance device.

When mounted on the stroller, an upper end of the blanket may be folded down over the bumper bar to provide access to a child within the stroller or to expose the child's face so the child can see out from beneath the blanket.

In some embodiments, the blanket 100 may include an internal structure which may facilitate an opening of the blanket from a folded to an unfolded state. For example a spring-like wire structure internal to the blanket, for example, internal to one or more edges of the blanket, may be provided which would expand or guide the blanket into an at least partially open state upon release of a force maintaining the blanket in a folded or closed state, for example when removed from a storage pocket.

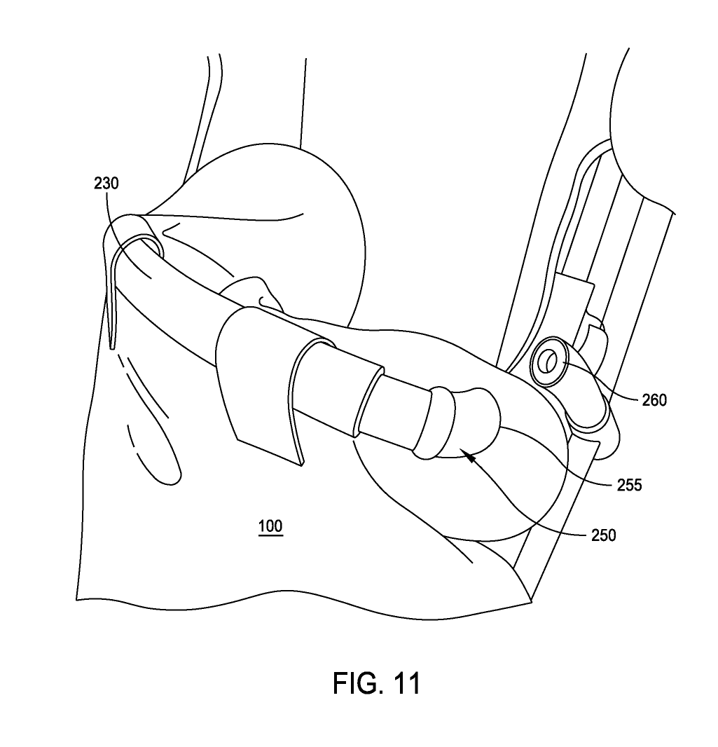

In some embodiments the bumper bar may be removably attached, at least on one end, to the frame of the stroller 200. For example, as illustrated in FIG. 11, a proximal end 250 of the bumper bar 230 may include a fastener 255 which may releasably engage a receiving element 260, in the frame of the stroller. The bumper bar fastener 255 may be released from the stroller by the depression of a button or latch (not shown) and may snap back into place when directed into the receiving element 260. A distal end of the bumper bar may include a hinge or similar device which may permit the bumper bar to swing away from the body of the stroller when the bumper bar fastener 255 is disengaged from the receiving element 260 of the stroller frame. Separating an end of the bumper bar from the frame of the stroller may facilitate a user attaching the blanket to the stroller by running the bumper bar 230 through the one or more loops 130 on the blanket.

In some embodiments, the support surface or seat 240 of the stroller 200 may be removable from the frame 210, and may function as a car seat. A separate mounting frame or bracket (not shown) may be installed in a ca to receive the support surface or seat 240 of the stroller and lock it in place for use as a car seat.

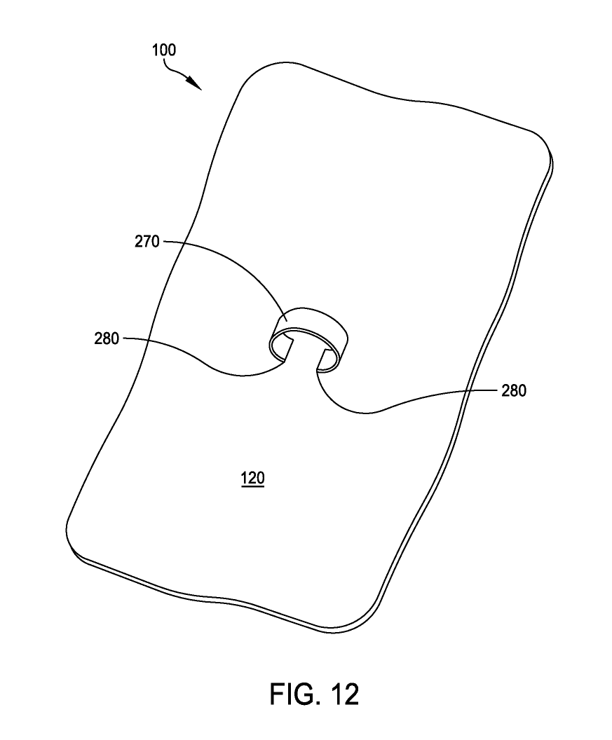

In a further embodiment, as illustrated in FIG. 12, the blanket 100 may be provided with one or more loops 270 on a lower side 120 thereof. The loop 270 may have an axis substantially parallel to a long side of the blanket 100 or to a short side of the blanket 100. The loop 270 may be fabricated from similar materials as the loops 130, 150 described above. Ends 280 of the loop 270 may be secured to the blanket using methods similar to those described for the ends 140, 140a, and/or 140b of the loop 130 described above. In some embodiments the loop 270 may comprise two sections of material, similar to loop sections 130a and 130b described above. In use, a harness buckle strap, or other strap of a child conveyance device, for example, a stroller or a car seat, can be threaded through the loop 270 to prevent the blanket from siding off of the child conveyance device. The loops 270 may be used to secure the blanket 100 to a child conveyance device which does not have a bumper bar.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A child conveyance device comprising:
a frame assembly; and
a blanket including:
a front surface;
a back surface; and
at least one loop affixed to the front surface, the at least one loop having a first end and a second end, the at least one loop being configured to detachably attach the blanket to the frame assembly.

2. The child conveyance device of claim 1, wherein the frame assembly includes a bumper bar.

3. The child conveyance device of claim 2, wherein the at least one loop is configured to detachably attach the blanket to the bumper bar and secure the blanket below the bumper bar by detachably attaching the blanket to the bumper bar.

4. The child conveyance device of claim 3, wherein the blanket further comprises an upper portion configured to fold over the bumper bar.

5. The child conveyance device of claim 3, wherein the bumper bar comprises a distal end and the distal end is detachable from the frame.

6. The child conveyance device of claim 1, wherein the first end and the second end of the at least one loop is permanently attached to the blanket.

7. The child conveyance device of claim 1, wherein one of the first end and the second end of the at least one loop is removably attached to the blanket.

8. The child conveyance device of claim 7, wherein the one of the first end and the second end of the at least one loop is removably attached to the blanket with a fastening means selected from the group consisting of buttons and button holes, snaps and fasteners, hooks and eyes, clasps, clips, and hook and loop fasteners.

9. The child conveyance device of claim 1, wherein the blanket further comprises a pocket configured to enclose the blanket when folded into itself.

10. The child conveyance device of claim 1, wherein the blanket has a width substantially equal to a width of the child conveyance device.

11. The child conveyance device of claim 1, further comprising a support surface configured to support a child, wherein the blanket has a length substantially equal to a length of the support surface.

12. The child conveyance device of claim 1, wherein the child conveyance device comprises a stroller.

13. The child conveyance device of claim 1, wherein the child conveyance device comprises a car seat.

14. The child conveyance device of claim 1, wherein the blanket has a top edge and each of the plurality of loops are positioned an equal distance from the top edge.

15. A method of attaching a blanket to a child conveyance device, the method comprising:
providing a child conveyance device comprising a frame and a bumper bar having a proximal end removably attached to the frame;
providing a blanket including:
a front surface;
a back surface; and
at least one loop affixed to the front surface, the at least one loop having a first end and a second end, the at least one loop being configured to detachably attach the blanket to the bumper bar and to secure the blanket below the bumper bar; and
attaching the at least one loop to the bumper bar.

16. The method of claim 15, wherein attaching the at least one loop to the bumper bar comprises:
detaching the proximal end of the bumper bar from the frame;
inserting the proximal end of the bumper bar through the at least one loop; and
re-attaching the proximal end of the bumper bar to the frame.

17. The method of claim 15, wherein one of the first end and the second end of the at least one loop is removably attached to the blanket and attaching the at least one loop to the bumper bar comprises:
removing the one of the first end and the second end of the at least one loop from the blanket;
positioning the at least one loop about a portion of the bumper bar; and
re-attaching the one of the first end and the second end of the at least one loop from the blanket.
